(19) United States
(12) Patent Application Publication
(10) Pub. No.: US 2005/0218085 A1
(43) Pub. Date: Oct. 6, 2005

(54) Ozone sterilization method and device for water supply drainage

(75) Inventor: Jae-Yun Song, Chungju-si (KR)

Correspondence Address: PARK & SUTTON LLP, 3255 WILSHIRE BLVD, SUITE 1110, LOS ANGELES, CA, 90010, US

(73) Assignees: YOUNG CHUL SONG; JAE YUN SONG; JOO BONG LEE

(21) Appl. No.: 10/857,113

(22) Filed: Jun. 1, 2004

(30) Foreign Application Priority Data
Apr. 2, 2004 (KR) 10-2004-0023014

(51) Int. Cl. C02F 1/78; C02F 1/50

(52) U.S. Cl. 210/760; 210/199

(57) ABSTRACT

The present invention relates to an ozone sterilization device and method for sterilizing source water of water supply drainage using ozone generated in an ozone generator. The method includes a first process in which source water inputted to a first water block is sucked and discharged; a second process in which source water is sprayed onto ozone through the first ejector, wherein the above routine is repeatedly performed for thereby generating ozone water; a third process in which the ozone water which source water and ozone is mixed is discharged to the discharge unit separated by the first water block, and the ozone not dissolved is collected by a first gas staying tank; and a fourth process in which the source water of the inlet unit is sucked and passed through a second ejector, and the ozone from the first gas staying tank is sucked by a second vacuum pipe.

### CLAIMING FOREIGN PRIORITY

The applicant claims and requests a foreign priority, through the Paris Convention for the Protection of Industry Property, based on a patent application filed in the Republic of Korea (South Korea) with the filing date of Apr. 2, 2004, with the patent application number 10-2004-0023104, by the applicant. (See the attached Declaration)

### BACKGROUND OF THE INVENTION

1. Field of the Invention

The present invention relates to an ozone sterilization method and device for water supply drainage, and in particular to an ozone sterilization method and device for water supply drainage that do not produce residual ozone for thereby omitting a process facility of residual ozone in such a manner that a fluid cavitation phenomenon is repeatedly adapted.

2. Description of the Background Art

Ozone is known to have strong oxidation force compared to chlorine. Ozone has advantages that oxidation speed is high, and residual substances are not made after deodorization and sterilization. It is very important to effectively contact ozone generated by an ozone generator with treated process water. When contacting ozone with treated process water, the efficiency of the whole processes may be decreased when the contacting efficiency is decreased. At this time, since ozone that is not absorbed by water is discharged into the air, it is not properly processed in the air for thereby causing various environmental problems. Therefore, the optimum contact method is needed by carefully discharged into the air, it is not properly processed in the air for thereby causing various environmental problems. Therefore, the optimum contact method is needed by carefully reviewing contact time, process purpose, energy consumption amount, etc. More advanced analyzing research is needed. In a contacting method between ozone and water, there are known scattering method, pressurized injector method, Venturi injector method, etc.

The scattering method is achieved in such a manner that ozone is contacted with water through porous scattering tube made of a zone-based material like ceramic or stainless in ozone gas. In the above method, when foams are moved up to the surface of water, ozone is dissolved in water, and residual ozone discharged to the upper side is reused. In the pressurized injector method, water to be treated and ozone are concurrently pressurized for thereby achieving high-speed process. In this case, since remaining effect of ozone is high, the above method is used for water purification or water treatment for swimming pool, etc. In the Venturi injector method, in a state that pressure is applied by a pump, a treated water is passed through a Venturi tube, generating a negative pressure. Ozone gas is sucked using the above negative pressure. Ozone is transferred to a contact tank in a state that it is mixed with gas and liquid, so that ozone gas having a lower pressure is contacted. This method is directed to thermally cracking surplus ozone gas or surplus ozone is passed through active carbon.

In the above-described methods, aeration method is adapted for inputting ozone into water. Here, the amount of ozone generated during excitation is very small. Namely, a large amount of ozone is not used but discharged into the air. In the case of the aeration method, about 30% through 60% of ozone is mixed with water. A surplus ozone treatment apparatus is needed after generation of ozone water. In addition, the above-described methods are not well adapted to the places where need a large amount of ozone water.

In the Korean registered patent No. 0135460 (fabrication method of ozone water, and method of using ozone water) invented by the applicant of the present invention, a new method has been developed for thereby largely enhancing dissolution efficiency of ozone. In the above method, a pressurizing tank is adapted and achieved in such a manner that gaseous particles are agitated based on gas and liquid and are treated to have a super critical state in which bubbles are not seen. The above method can be easily used with a certain concentration that a customer wants at home or in business field. However, a power source is separately needed for a water analysis agitating apparatus, and dissolved gases are unstable due to turbulence by the agitating apparatus. In the case that the pressure condition is not satisfied, ozone gas may be easily separated from ozone water.

In addition, in the Korean registered patent No. 0242413 (ozone water fabrication method and apparatus) invented by the applicant of the present invention, a very advanced method has been developed for fabricating ozone water in such a manner that water is sprayed onto ozone gas, differently from the conventional method in which ozone is inputted into water.

Furthermore, in the Korean registered patent No. 0294793 (method for fabricating gas dissolved water in pressurized spraying method) invented by the applicant of the present invention, the dissolution is further promoted by installing a nozzle at a lower side of a mixing dissolution machine. The ozone is pressurized and stabilized in the pressure tank for thereby enhancing a dissolution ratio. Residual ozone gas is analyzed through an ozone thermal analysis apparatus or an ozone activation analysis tank for thereby processing residual ozone. However, in the above-described methods, ozone is mixed with water, the water mixed with ozone is passed through a mixing dissolution device and is reacted in the pressurizing tank for thereby producing ozone water. Non-reacted ozone should be separated from gas, and residual ozone should be separately processed. In addition, the above method is directed to processing polluted water itself. Namely, the ozone treatment is performed with respect to all polluted water, and then the following work is performed. Therefore, a large amount of power is consumed for treating all polluted water, and an apparatus cost, and maintenance cost are increased.

### SUMMARY OF THE INVENTION

Accordingly, it is an object of the present invention to provide an ozone sterilization method and device for water supply drainage in which a dissolution efficiency of ozone and excellent, and no residual ozone is produced in such a manner that cavitation of fluid is repeatedly adapted in a method of dissolving liquid and gas (ozone) in an environmental field.

It is another object of the present invention to provide an ozone sterilization method and device for water supply drainage capable of achieving an environment friendly system as compared to a sterilization using fluorine or chloride, and the cost problem in a conventional process method using ozone is overcome.

It is further another object of the present invention to provide an ozone sterilization method and device for water supply drainage capable of accurately adjusting the amount of inputted ozone by adjusting the input amount of ozone based on pollutant such as oxidized material, organic material, etc., and decreasing ozone process time from minute unit to second unit. In addition, residual ozone treatment facility is not needed based on full process of ozone for thereby preventing pollution.

It is still further another object of the present invention to provide an ozone sterilization method and device for water supply drainage that do not need a compressor for supplying ozone as compared to a conventional art in such a manner that ozone is sucked using vacuum phenomenon occurring due to a strong flow speed of source water.

To achieve the above objects, the present invention is implemented by fully mixing ozone based on cavitation phenomenon that occurs in such a manner that when source water flows in water supply drainage pipe or waste water pipe, the source water is pressurized with a constant pressure using a pump and is passed through a small size part in a state that ozone is sucked for thereby achieving high speed flow.

Here, the cavitation phenomenon will be described in more detail. In evaporation of liquid, as the temperature of liquid is increased, the liquid is boiled, and the cavitation occurs or as the pressure in liquid is decreased below vapor pressure, the cavitation occurs. In the present invention, the later phenomenon is adapted. Namely, when the flowing speed of fluid is increased, the pressure of the fluid is decreased below a saturation vapor pressure of the liquid in part. At this time, a cavitation bubble group formed of water molecular and non-condensed gas molecular are generated in liquid. When the flowing speed is decreased, and the pressure is recovered, each cavitation bubble forms a large impact pressure and a high temperature environment near the bubbles through a contraction, re-expansion and destruction, and at the same time a micro-jet occurs in the destroying bubbles. Various reactors are formed near the destroying bubbles. Each reactor operates as a micro-reactor, so that it is well reacted with surrounding reaction materials. In the above state, the reaction with ozone is very new. When reactors are sprayed to ozone, so that the dissolution ratio of ozone is significantly enhanced. The ozone agitated with reaction substance contained in source water is concurrently decreased at 1:1. As a high value of ozone is decreased, and the reaction substance contained in source water is decreased.

To achieve the above objects, there is provided an ozone sterilization apparatus for water supply drainage, comprising a first suction unit for sucking source water; a first source supply unit formed of a first pump and a first pipe way in order for the first suction unit to effectively suck source water; a first vacuum pipe of which one side sucks ozone, and the other side discharges the sucked ozone; a first ejector connected with the first source water unit and the first vacuum pipe for spraying source water onto ozone; a first critical pipe for spraying ozone water mixed by the first ejector onto the pipe way; a first aeration tank of which an upper side and lateral side surround an outer side of the first critical pipe, and a lower side is extended in the direction of water flow way; a first gas staying tank installed on an upper side of the first aeration tank for gathering ozone that is not dissolved when passing the first critical pipe; a second suction unit for sucking source water; a second source supply unit formed of a second pump and a second pipe way in order for the second suction unit to effectively suck source water; a second vacuum pipe of which one side connected with the first gas staying tank sucks ozone, and the other side discharges the sucked ozone; a second ejector connected with the second source water unit and the second vacuum pipe for spraying source water onto ozone; a second critical pipe for spraying ozone water mixed by the second ejector onto the pipe way; a second aeration tank of which an upper side and lateral side surround an outer side of the second critical pipe, and a lower side is extended in the direction of water flow way; and a second gas staying tank installed on an upper side of the second aeration tank for gathering ozone that is not dissolved when passing the second critical pipe.

Preferably, there is further provided an ozone analysis apparatus that has active carbon in the interior of the same, wherein one side of the same is extended from the second gas staying tank, and the residual gas collected by the second gas staying tank is passes through the active carbon and is removed.

Preferably, first and second water pressure gauges are installed at one side of the first and second pipe ways, and a sensor is installed at one side of the first water pressure gauge for stopping an operation of the system when the pressure exceeds a certain set range of the water pressure gauge.

Preferably, the first ejector includes an ejector reduction pipe in which a diameter of an upper side connected with the discharge unit of the first pipe way is gradually decreased, and an ejector expansion pipe in which a diameter of a lower side connected with the inlet unit of the first critical pipe is gradually increased, and a suction pipe is installed between the ejector reduction pipe and the ejector expansion pipe for sucking ozone from the first vacuum pipe.

Preferably, first and second negative and positive pressure gauges are installed at one side of the first ejector for measuring the positive pressure of the ozone inputted through the first and second vacuum pipes and the negative pressure of the source water inputted through the first and second pipe ways.

Preferably, a second water block is installed at one side of the discharge unit for discharging the discharge water when it reaches a certain amount wherein the discharge water is discharged to the first critical pipe.

Preferably, a sensor is installed at one side of each of the first, second and third vacuum pipes for measuring the concentration of ozone gas.

### BRIEF DESCRIPTION OF THE DRAWINGS

The present invention will become better understood with reference to the accompanying drawings which are given only by way of illustration and thus are not limitative of the present invention, wherein;

FIG. 1 is a perspective view illustrating an ozone sterilization apparatus for water supply drainage according to the present invention;

FIG. 2 is a partial horizontal cross sectional view taken along line A-A of FIG. 1 according to the present invention;

FIG. 3 is a perspective view of a first ozone process based on the construction of FIG. 1;

FIG. 4 is an inner cross sectional view illustrating first and second ejectors according to the present invention;

FIG. 5 is a perspective view of a second ozone process based on the construction of FIG. 1;

FIG. 6 is a perspective view illustrating an ozone sterilization apparatus for water supply drainage according to another embodiment of the present invention;

FIG. 7 is a partial horizontal cross sectional view of line B-B' of FIG. 6;

FIG. 8 is a perspective view of a first ozone process based on the construction of FIG. 6;

FIG. 9 is a cross sectional view for describing an operation of a critical pipe and an aeration tank according to the present invention; and

FIG. 10 is a perspective view of a second ozone process based on the construction of FIG. 6 according to the present invention.

### DETAILED DESCRIPTION OF THE PREFERRED EMBODIMENTS

The preferred embodiments of the present invention will be described with reference to the accompanying drawings.

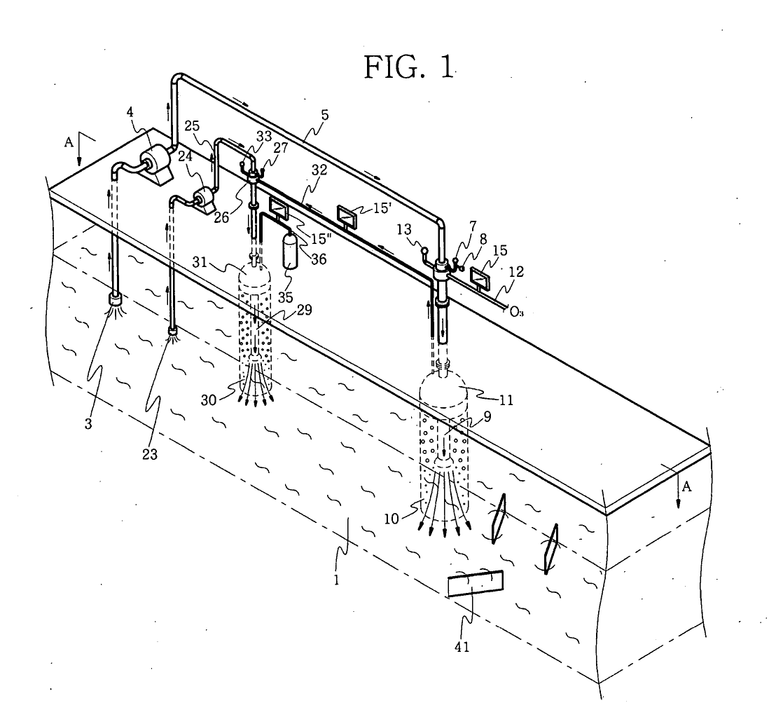

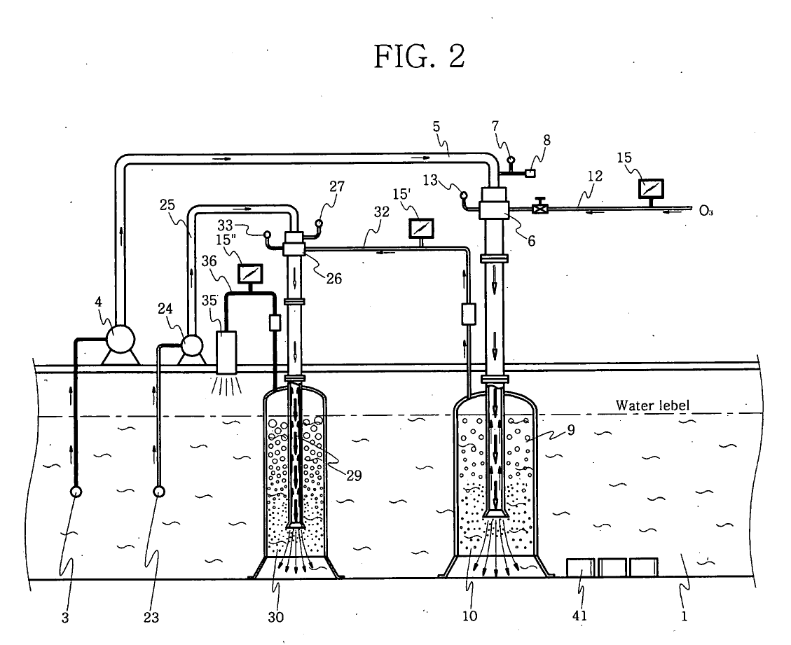

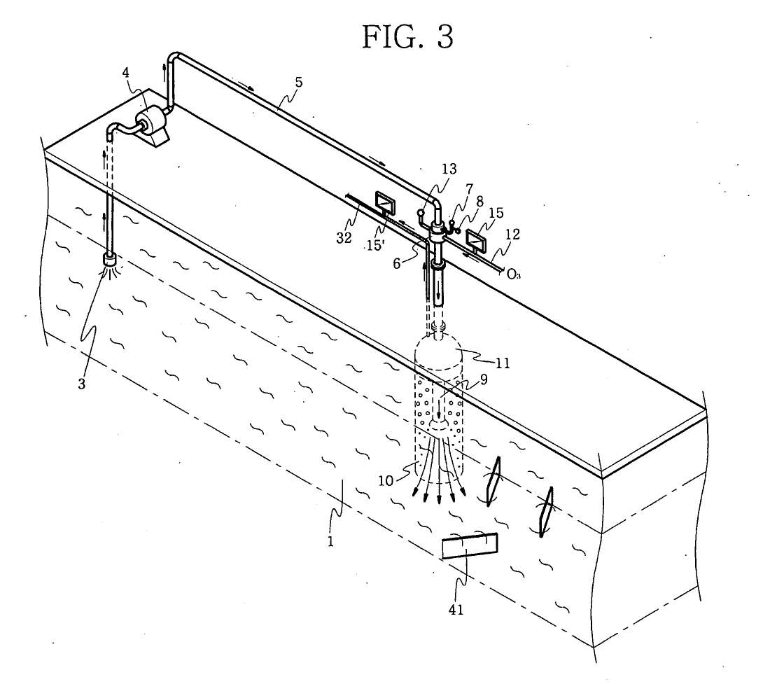

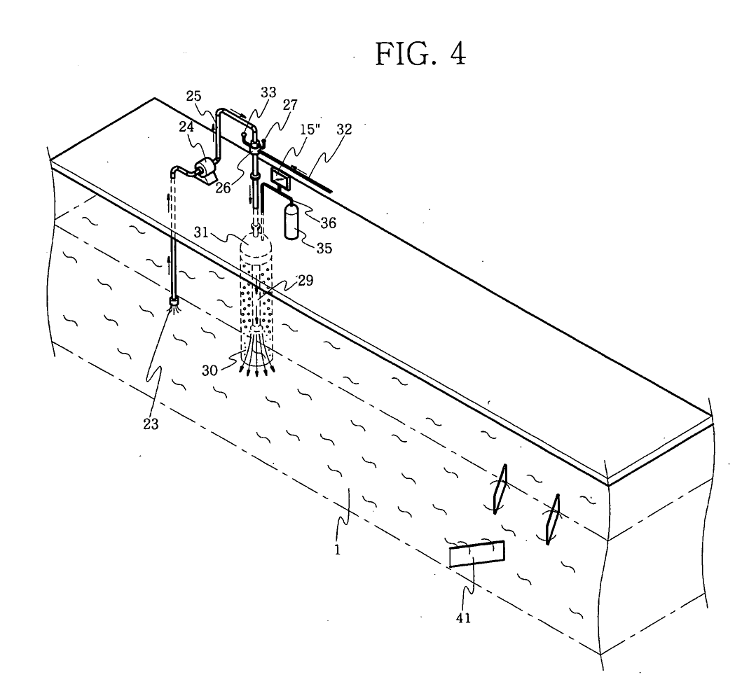

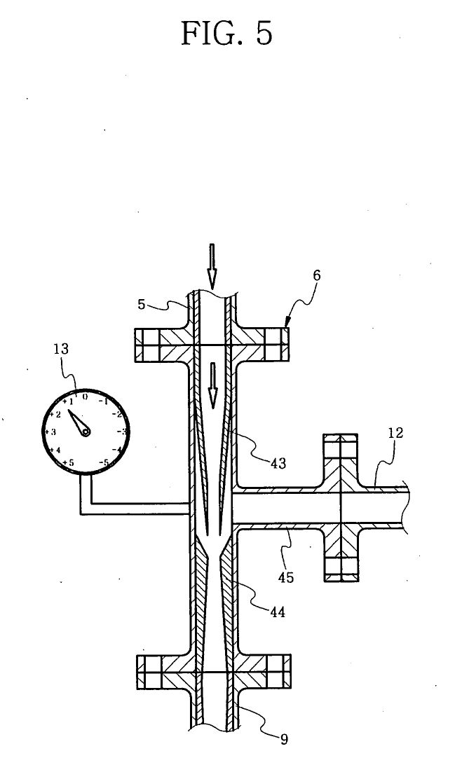

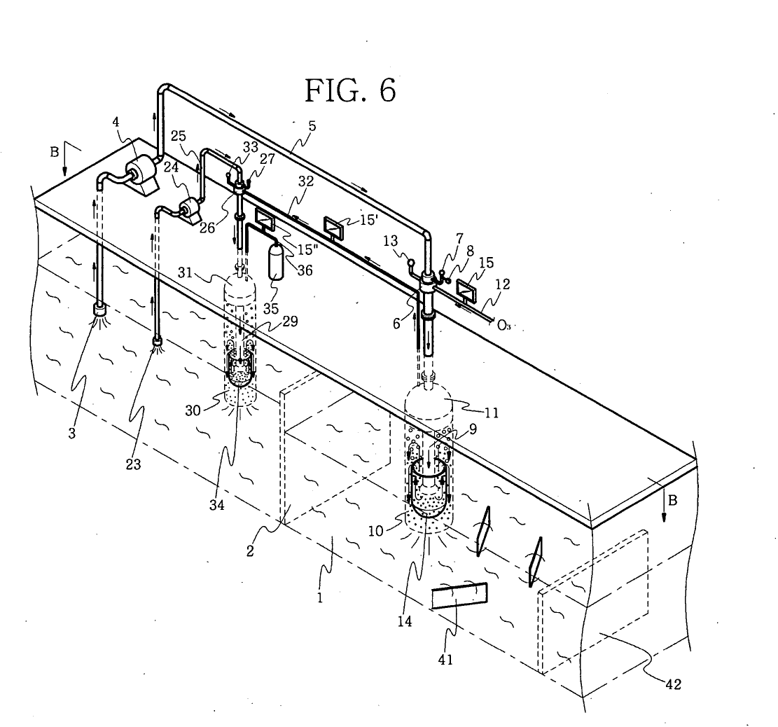

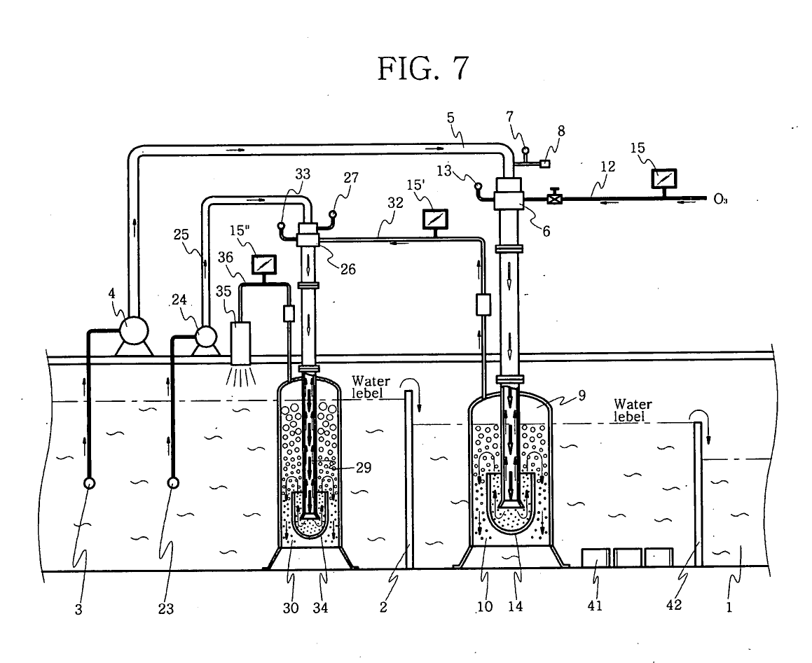

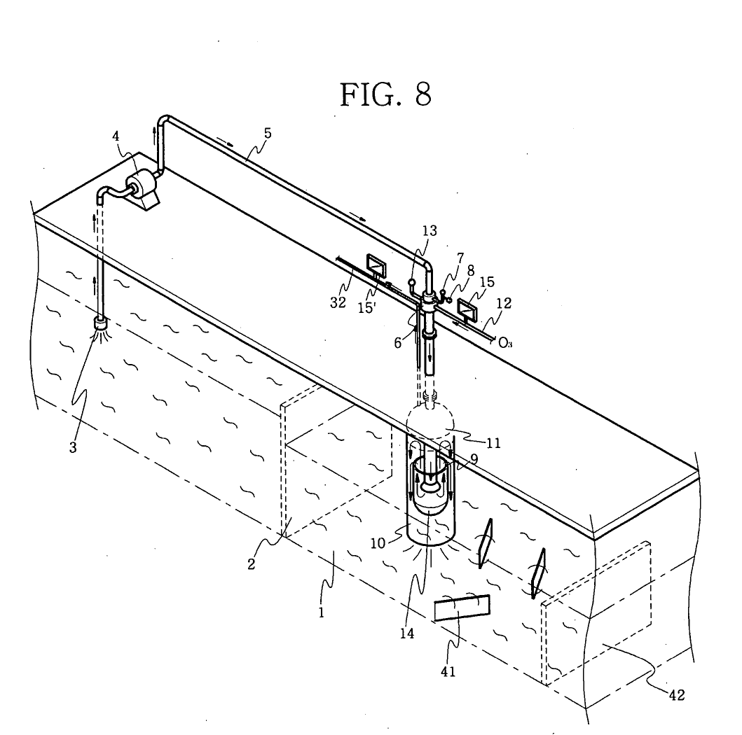

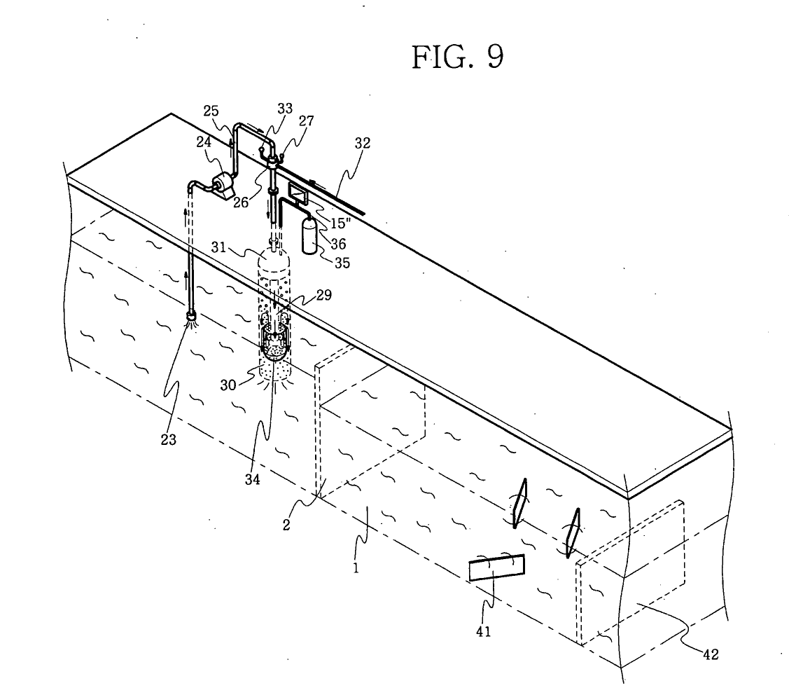

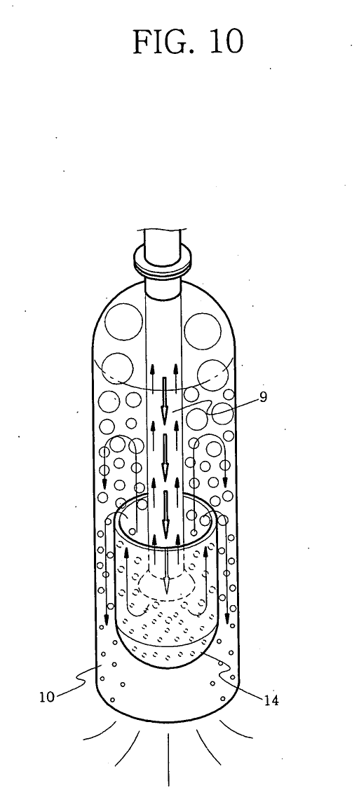

FIG. 1 is a perspective view illustrating an ozone sterilization apparatus for water supply drainage according to the present invention, FIG. 2 is a partial horizontal cross sectional view taken along line A-A of FIG. 1 according to the present invention, FIG. 3 is a perspective view of a first ozone process based on the construction of FIG. 1, FIG. 4 is an inner cross sectional view illustrating first and second ejectors according to the present invention, FIG. 5 is a perspective view of a second ozone process based on the construction of FIG. 1, FIG. 6 is a perspective view illustrating an ozone sterilization apparatus for water supply drainage according to another embodiment of the present invention, FIG. 7 is a partial horizontal cross sectional view of line B-B' of FIG. 6, FIG. 8 is a perspective view of a first ozone process based on the construction of FIG. 6, FIG. 9 is a cross sectional view for describing an operation of a critical pipe and an aeration tank according to the present invention, and FIG. 10 is a perspective view of a second ozone process based on the construction of FIG. 6 according to the present invention. Here, when describing the present invention, the related known art and construction of the same will be omitted for a clear understanding of the present invention.

The ozone treatment apparatus according to an embodiment of the present invention will be described with reference to FIGS. 1 through 5.

As shown in FIGS. 1 through 3, a first ozone treatment will be described. When source water is inputted into a water supply drainage pipe or a waste water pipe 1, a first pump 4 is operated, and the source water is first sucked into a first suction unit 3. The sucked source water is inputted into a first ejector 6 through a first pipe way 5 with a pumping pressure of 23 M through 25 M. At this time, a first water pressure gauge 7 installed in one side of the first pipe way checks the pressure of source water. When the pressure of the checked source water exceeds a certain range, a sensor 8 installed in one side of the first water pressure gauge 7 operates, so that the operation of the ozone sterilization is automatically stopped.

The ozone mixed with the source water is inputted into the first ejector 6 through a first vacuum pipe 12. At this time, the concentration of ozone inputted through the first vacuum pipe is preferably 3% (30,000 ppm) through 12% (120,000 ppm).

A vacuum phenomenon (hereinafter referred to as a critical phenomenon) occurs in the source water inputted into the interior of the first ejector 6 based on a strong pressure and high speed of the source water. The critical phenomenon operates with the pressure and speed of ozone inputted into the interior of the first critical pipe 9 and is increased. Here, the critical phenomenon has a pressure of ozone (hereinafter referred to positive pressure) supplied to the first ejector 6 and a pressure of ozone (hereinafter referred to as negative pressure) sucked by the source water inputted into the first ejector 6 and represents the operations that the source water passing through the interior is exploded as the interior of the first critical pipe has a vacuum phenomenon. Namely, the above explosion may be referred to as cavitation. The above phenomenon is repeatedly performed.

As shown in FIG. 4, the first ejector 6 includes an ejector reduction pipe 43 of which the diameter of its upper side connected to the first pipe way 5 is gradually decreased, an ejector expansion pipe 44 of which the diameter of its lower side connected with the first critical pipe is gradually increased, and a suction pipe 45 into which ozone from the first vacuum pipe 12 between the ejector reduction pipe 43 and the ejector expansion pipe 44 is inputted. Therefore, the flow speed of the source water inputted into the first ejector through the first pipe way is increased when it passes through the reduced diameter portion of the ejector reduction pipe 43 for thereby strongly sucking and mixing the ozone inputted into the suction pipe 45, so that the cavitation phenomenon occurs. Thereafter, the ozone water passing through the ejector expansion pipe 44 has a strong flow speed, passing through the portion in which the diameter is gradually increased, so that the mixed ozone get pressurized and dissolved. The dissolved ozone reacts with oxidation substance and organic substance contained in the source water for thereby achieving sterilization.

Here, it is possible to control the pressure and speed of the source water and ozone for thereby generating cavitation phenomenon in such a manner that the positive pressure of the ozone inputted into a first negative and positive pressure gauge 12 installed in one side of the first ejector 6 through the first vacuum pipe 12 is measured, and the negative pressure capable of sucking the source water inputted through the first pipe way is measured. In addition, it is possible to adjust the amount of ozone based on the amount of oxidation substance and organic substance included in the source water.

The ozone water mixed with ozone in the interior of the first ejector 6 is discharged to the water supply drainage pipe or the waster water pipe through the first critical pipe 9.

The ozone water from the first critical pipe 9 flows into the pipe through the lower side of a first aeration tank surrounding the first critical pipe, and the ozone that is not dissolved by source water is gathered at a first gas staying tank 11 installed on an upper side of the first aeration tank 10. More than about 95% ozone inputted into the first ejector 6 through the above procedures is dissolved.

An ozone check sensor and monitors 15, 15′ may be installed in one side of each of the first vacuum pipe 12 and the first gas staying tank 11 in order to check a result of the process in which ozone is dissolved.

The second ozone treatment procedures of the ozone treatment apparatus according to an embodiment of the present invention will be described with reference to FIG. 5.

In order to process ozone gathered at the first gas staying tank 11, the second pump 24 is operated, and the source water of the water supply drainage pipe or the waste water pipe 1 is sucked using the second suction unit 23. The sucked source water is inputted into the second ejector 26 through the second pipe way 25. At this time, the pressure of the source water inputted into the second ejector 26 is checked by the second water pressure gauge 27 installed in one side of the second pipe way.

The ozone gathered at the first gas staying tank 11 is inputted into the second ejector 26 through the second vacuum pipe 32. The ozone is sucked based on the vacuum phenomenon occurring due to the strong pressure and high speed of the source water passing through the second critical pipe 29 and is mixed with the source water. The second ejector 26 has the same shape as the first ejector 6. A pump may be installed at the second vacuum pipe for adjusting the pressure of the ozone.

In the second ejector 26, the vacuum phenomenon occurs due to the strong pressure and high speed of the source water inputted into the second ejector 26 based on the same operation as the first ejector. The source water is sprayed to the ozone inputted based on the above vacuum phenomenon, namely, the cavitation phenomenon. It is possible to adjust the speed and pressure of the source water, so that the cavitation phenomenon occurs well by measuring the positive pressure of the ozone inputted through the second vacuum pipe 32 and the negative pressure of the ozone inputted through the first pipe way using the second negative and positive pressure gauge 33.

The ozone water having the critical phenomenon based on the above operation passes through the second critical pipe 29 and is discharged to the water supply drainage pipe or waste water pipe 1 and is mixed with the source water that does not pass through the above apparatus, so that the sterilization is achieved by the source water by ozone dissolved in the ozone water.

At this time, the ozone water discharged from the second critical pipe 29 is discharged along the pipes through the lower side of the second aeration tank 30 surrounding the second critical pipe 29. The gas that is not dissolved in the ozone water is gathered at the second gas staying tank 31 positioned at the upper side of the second aeration tank 30. The ozone components included in the second ejector 6 is fully dissolved and disappears through the above procedures.

In order to achieve a satisfied process of ozone that is not mixed in the second ejector 26, the gas gathered at the second gas staying tank 31 is inputted into an ozone analysis apparatus 35 having active carbon (not shown) through a third vacuum pipe extended from the upper side of the second gas staying tank 31 and is fully removed and discharged as purified oxygen. At this time, an ozone check sensor (not shown) and a monitor (15″) may be installed in one side of the second gas staying tank 31, so that it is possible to check the concentration of the ozone contained in the gas inputted into the ozone analysis apparatus.

In addition, a static mixer 41 may be installed in flowing water at crossing positions for thereby achieving a desired mixing of ozone. The static mixer 41 capable of well mixing ozone does not need power. Namely, it is directed to forming turbulence in water using natural physical phenomenon for thereby achieving a desired mixing.

In the waste water treatment apparatus according to the present invention, the ozone is sucked based on the vacuum phenomenon occurring based on the strong pressure and high speed of the source water even when the ozone is not provided by the compressor in the conventional art. The ozone that is not dissolved through the first ozone dissolution is fully processed through the second ozone dissolution procedures.

The ozone treatment apparatus according to another embodiment of the present invention will be described with reference to FIGS. 6 through 10.

As shown in FIG. 6, a first water block 2 is formed at one side of the water supply drainage pipe or waste water pipe 1, so that the pipe 1 is divided into an inlet part into which source water is inputted, and a discharge part from which processed water is discharged. At this time, the first water block 2 is basically capable of blocking the flow of source water inputted, but is designed in such a manner that the upper side of the pipe 1 is not fully blocked so that the source water flows beyond the upper side of the first water block 2 when a certain amount of source water flows.

The first ozone treatment procedures of the ozone treatment apparatus according to another embodiment of the present invention will be described with reference to FIGS. 6 through 8. When the source water is inputted into the inlet part blocked by the first water block 2, the source water is sucked into the first suction unit 3 installed at one side of the inlet part by operating the first pump 4, and the sucked source water is inputted into the first ejector 6 through the first pipe way 5 with a pumping power of 23 M through 25 M. At this time, the pressure of the source water is checked by the first water pressure gauge 7 installed at one side of the first pipe way. When the pressure of the source water checked by the first water pressure gauge 7 exceeds a certain reference range, the operation of the ozone sterilization apparatus is automatically stopped based on an operation of a sensor 8.

The ozone mixed in the source water is inputted into the first ejector 6 through the first vacuum pipe 12. At this time, the concentration of the ozone inputted through the first vacuum pipe is 3% (30,000 ppm) through 12% (120,000 ppm).

A vacuum phenomenon occurs in the source water inputted into the interior of the first ejector 6 by the strong pressure and high speed of the source water. The vacuum phenomenon helps the ozone inputted into the interior of the first critical pipe 9 to be faster inputted. The source water is explosively sprayed to ozone based on the cavitation phenomenon, and the ozone is sucked and mixed. At this time, the first negative and positive pressure gauge 13 installed at one side of the first ejector 6 measures the positive pressure of the ozone inputted through the first vacuum pipe 123 and the negative pressure occurring based on the operation of the source water for thereby adjusting the pressure and speed of the source water and ozone.

The ozone water mixed with ozone based on the critical phenomenon by the first ejector 6 through the above procedures is discharged through a discharge part of the water supply drainage pipe or waste water pipe 1 blocked by the first water block through the lower side of the first critical pipe 9.

At this time, as shown in FIG. 9, the ozone water from the first critical pipe 9 collides with a U-shaped first water collector 14 installed in a lower side of the first critical pipe 9 and is analyzed into micro water molecular of which a part of the same is reverse-flown in the upper direction of the first critical pipe 9 and is fully mixed with the ozone water discharged from the first ejector 6 to the first critical pipe. At this time, the height of the first critical pipe 9 is preferably about 1.2 through 1.5 times with respect to the height of water flowing in the discharge part.

The discharged water of the first critical pipe 9 collided with the water block is discharged to the discharge part through a space between the U-shaped first water collector 14 and the first aeration tank 10. The ozone that is not dissolved into source water is gathered at the first gas staying tank 11 positioned at the top of the first aeration tank 10. The ozone inputted into the first ejector 6 through the above procedures is decreased from ten thousands unit to hundreds units, and more than 95% of the ozone is dissolved.

The second ozone treatment of the ozone treatment apparatus according to another embodiment of the present invention will be described with reference to FIG. 10.

As shown therein, in order to process the ozone gathered at the first gas staying tank 11, the second pump 24 is operated. The source water is sucked by the second suction unit 23 installed at one side of the inlet unit and is inputted into the second ejector 26 through the second pipe way 25.

The ozone gathered at the first gas staying tank 11 is inputted into the second ejector 26 through the second vacuum pipe 32 and is sucked by the vacuum phenomenon occurring based on the strong pressure and high speed of the source water passing through the second critical pipe 29 and is mixed with the source water. The second ejector 26 has the same shape as the first ejector 6. A pump may be installed in the second vacuum pipe in order to adjust the pressure of the ozone. At this time, the second negative and positive pressure gauge 33 may be installed for measuring the pressure of the source water inputted into the second ejector 26 and the pressure of the ozone.

The ozone water having the critical phenomenon through the above procedures is inputted into the inlet unit of the water supply drainage pipe or waste water pipe 1 blocked by the first water block through the second critical pipe 29. At this time, the ozone water collides with the U-shaped second water collector 14 installed at the lower side of the second critical pipe 29 and is analyzed into micro water molecular of which a part of the same is reverse-flown in the upper direction of the second critical pipe 29 and is mixed with the ozone water flowing from the upper side for thereby achieving an easier mixing with ozone.

The discharge water from the second critical pipe through the above procedures is discharged through the discharge unit through the space between the U-shaped second water collector and the second aeration tank 30, and the gas that is not dissolved into source water is collected at the second gas staying tank 31 installed at the upper side of the second aeration tank 30. The ozone inputted into the second ejector 26 through the above procedure is fully dissolved.

The gas gathered at the second gas staying tank 31 flows through a third vacuum pipe 36 extended from the upper side of the second gas staying tank 31 and is inputted into the ozone analysis apparatus 35 having active carbon (not shown) and is fully purified and changed into oxygen.

In addition, the ozone water from the second critical pipe 9 is well diluted with the source water passing through the upper side of the first water block 42 and passes through the static mixer 41 for thereby achieving a desired sterilization based on ozone dissolved therein.

After a certain amount of discharge water is inputted into the discharge unit, it is discharged beyond the second water block 42.

As described above, in the present invention, the source water passing through the water supply drainage pipe is explosively analyzed based on the cavitation phenomenon, so that the pollutant is oxidized and analyzed, and is sprayed onto ozone. Therefore, the dissolution of ozone is enhanced, and the amount of the residual ozone is significantly decreased, and the source water is effectively sterilized using the ozone.

In addition, the source water is retreated using a small amount of residual ozone, so that it is not needed to install the residual ozone facility for thereby preventing environment pollution by residual ozone. The facility and maintenance cost is significantly decreased.

The ozone is sucked based on a vacuum phenomenon occurring due to the strong pressure and high speed of the source water, so that it is not needed to use the compressor for supplying ozone as compared to the conventional art.

The ozone sterilization apparatus for water supply drainage according to the present invention may be well adapted when dissolving gas such as oxygen, etc. into liquid except for waste water.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. An ozone sterilization apparatus for water supply drainage, comprising:
a first suction unit for sucking source water;
a first source supply unit formed of a first pump and a first pipe way in order for the first suction unit to effectively suck source water;
a first vacuum pipe of which one side sucks ozone, and the other side discharges the sucked ozone;
a first ejector connected with the first source water unit and the first vacuum pipe for spraying source water onto ozone;
a first critical pipe for spraying ozone water mixed by the first ejector onto the pipe way;
a first aeration tank of which an upper side and lateral side surround an outer side of the first critical pipe, and a lower side is extended in the direction of water flow way;
a first gas staying tank installed on an upper side of the first aeration tank for gathering ozone that is not dissolved when passing the first critical pipe;
a second suction unit for sucking source water;
a second source supply unit formed of a second pump and a second pipe way in order for the second suction unit to effectively suck source water;
a second vacuum pipe of which one side connected with the first gas staying tank sucks ozone, and the other side discharges the sucked ozone;
a second ejector connected with the second source water unit and the second vacuum pipe for spraying source water onto ozone;
a second critical pipe for spraying ozone water mixed by the second ejector onto the pipe way;
a second aeration tank of which an upper side and lateral side surround an outer side of the second critical pipe, and a lower side is extended in the direction of water flow way; and
a second gas staying tank installed on an upper side of the second aeration tank for gathering ozone that is not dissolved when passing the second critical pipe.

2. The apparatus of claim 1, wherein first or second negative and positive pressure gauge is installed in one side of the first ejector or second ejector for measuring a positive pressure of ozone inputted through the first or second vacuum pipe and a negative pressure of source water inputted through the first or second pipe way.

3. The apparatus of claim 1, wherein first or second water pressure gauge is installed at one side of the first or second pipe way.

4. The apparatus of claim 1, wherein a sensor is installed at one side of the first water pressure gauge for stopping an operation of the system in the case that the pressure exceeds a certain set range of the water pressure gauge.

5. The apparatus of claim 1, further comprising a static mixer for effectively mixing the processed water from the first critical pipe.

6. An ozone sterilization apparatus for water supply drainage, comprising:
a first water block formed at one side of water way for blocking source water flowing into an inlet unit and discharge unit;
a first suction unit for sucking source water inputted into the water way in the inlet unit of the water way;
a first source supply unit formed of a first pump and a first pipe way in order for the first suction unit to effectively suck source water;
a first vacuum pipe of which one side sucks ozone, and the other side discharges the sucked ozone;
a first ejector connected with the first source water unit and the first vacuum pipe for spraying source water onto ozone and mixing the same;
a first critical pipe for mixing the ozone inputted into the first vacuum pipe and the source water sprayed by the first ejector and spraying to the discharge unit of the water flow way;
a first aeration tank of which an upper side and lateral side surround an outer side of the first critical pipe, and a lower side is extended in the direction of water flow way;
a U-shaped water collector surrounding a lower side of the first critical pipe;
a first gas staying tank installed on an upper side of the first aeration tank for gathering ozone that is not dissolved when passing the first critical pipe;
a second suction unit for sucking source water inputted into the water way in the inlet unit of the water way;
a second source supply unit formed of a second pump and a second pipe way in order for the second suction unit to effectively suck source water;
a second vacuum pipe of which one side connected with the first gas staying tank sucks ozone, and the other side discharges the sucked ozone;
a second ejector connected with the second source water unit and the second vacuum pipe for spraying source water onto ozone and mixing the same;
a second critical pipe for mixing the ozone water mixed by the second ejector and spraying into the inlet unit of the water flow way;
a second aeration tank of which an upper side and lateral side surround an outer side of the second critical pipe, and a lower side is extended in the direction of water flow way;
a U-shaped water collector surrounding a lower side of the first critical pipe; and
a second gas staying tank installed on an upper side of the second aeration tank for gathering ozone that is not dissolved when passing the second critical pipe.

7. The apparatus of claim 6, wherein first or second negative and positive pressure gauge is installed in one side of the first ejector or second ejector for measuring a positive pressure of ozone inputted through the first or second vacuum pipe and a negative pressure of source water inputted through the first or second pipe way.

8. The apparatus of claim 6, wherein first or second water pressure gauge is installed at one side of the first or second pipe way.

9. The apparatus of claim 6, wherein a sensor is installed at one side of the first water pressure gauge for stopping an operation of the system in the case that the pressure exceeds a certain set range of the water pressure gauge.

10. The apparatus of claim 6, further comprising a static mixer for effectively mixing the processed water from the first critical pipe.

11. The apparatus of claim 6, further comprising a second water block formed at one side of the discharge unit for discharging water having a certain level to the outside.

12. An ozone sterilization method for sterilizing source water of water supply drainage using ozone generated in an ozone generator, comprising:
a first process in which when source water is inputted through an inlet unit separated by a first water block, the inputted source water is sucked by a first suction unit and is discharged to a first ejector;
a second process in which the source water is exploded based on cavitation under a critical condition in such a manner that a pressure of source water passing through the first ejector and a pressure of ozone inputted from the ozone generator are adjusted, and source water is sprayed onto ozone, wherein the above routine is repeatedly performed for thereby generating ozone water;
a third process in which the ozone water of which source water and ozone are mixed by the first ejector, is discharged to the discharge unit separated by the first water block through the first critical pipe, and the ozone that is not dissolved into discharge water from the first critical pipe is collected by a first gas staying tank;
a fourth process in which the source water of the inlet unit is sucked by a second suction unit and is passed through a second ejector for achieving a fast flow, and the ozone from the first gas staying tank is sucked by a second vacuum pipe;
a fifth process in which the source water passed through the second ejector is exploded based on a cavitation under a critical condition, and the source water is sprayed onto the sucked ozone, wherein the above routine is repeatedly performed for thereby generating ozone water; and
a sixth process in which the ozone water formed of source water and ozone by the second ejector is discharged to the inlet unit separated by a first water block through a second critical pipe.

13. The method of claim 12, further comprising a process in which a negative pressure of the source water inputted into the ejector and a positive pressure of the ozone are measured for thereby adjusting a suction speed of the source water in connection with the first ejector and second ejector of said second process and said fifth process.

14. The method of claim 12, further comprising a seventh process in which the ozone that is not dissolved by discharge water from the second critical pipe is collected by the second gas staying tank, and the collected ozone is passed through an ozone analysis apparatus having active carbon and is removed.

15. The method of claim 14, further comprising a process in which a negative pressure of the source water inputted into the ejector and a positive pressure of the ozone are measured for thereby adjusting a suction speed of the source water in connection with the first ejector and second ejector of said second process and said fifth process.

16. The method of claim 12, wherein in said third process and said sixth process, the discharge water from the first and second critical pipe are discharged to U-shaped first and second water collectors that surround the lower sides of the first and second critical pipes, and a part of the discharge water is reverse-flown to the first and second critical pipes and is mixed with the discharge water again.
